(19) United States
(12) Patent Application Publication
(10) Pub. No.: US 2004/0230479 A1
(43) Pub. Date: Nov. 18, 2004

(54) Display system

(75) Inventor: Hiroshi Ikeda, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA PHOTO IMAGING, INC.

(21) Appl. No.: 10/842,546

(22) Filed: May 11, 2004

(30) Foreign Application Priority Data
May 14, 2003 (JP) JP2003-135730

(51) Int. Cl. G06F 17/60

(52) U.S. Cl. 705/11

(57) ABSTRACT

There is described a display system, which makes it possible to display a process chart by which an operator can easily and visually recognize a residual working time, when the operator performs a job including more than two steps. The display system, which displays steps included in a consecutive operation on a display screen, includes: a measuring section to measure a working time for every step; a first storage section to store current data of the working time; a second storage section to store cumulative data of working times for every step performed in a past; and a displaying section to display the steps included in the consecutive operation on the display screen. The displaying section also displays working times, which are derived from the cumulative data of working times for every step performed in a past and the current data stored in the first storage section.

### BACKGROUND OF THE INVENTION

The present invention relates to a display system, which makes it possible to display a process chart by which an operator can easily and visually recognize a residual working time, when the operator performs a job including more than two steps.

Conventionally, when the operator performs a job including more than two steps, there has been well known a method for visually displaying the steps in parallel in a vertical direction (for instance, including step 1 to step 5 as shown in FIG. 13), or displaying the steps in serial in a horizontal direction (for instance, including step 1 to step 5 as shown in FIG. 14).

Although every conventional method can indicate a flow of the job, there has been a drawback that it is impossible to notify the operator of the working amount in each of the steps.

### SUMMARY OF THE INVENTION

To overcome the abovementioned drawbacks in conventional display system, it is an object of the present invention to provide a display system, which makes it possible to display a process chart by which an operator can easily and visually recognize a residual working time or a working amount in each of the steps, when the operator performs a job including more than two steps.

Accordingly, to overcome the cited shortcomings, the abovementioned object of the present invention can be attained by display systems described as follow.

(1) A display system for displaying steps included in a consecutive operation on a display screen, comprising: a measuring section to measure a working time for every step; a first storage section to store current data of the working time measured by the measuring section; a second storage section to store cumulative data of working times for every step performed in a past; and a displaying section to display the steps included in the consecutive operation on the display screen; wherein the displaying section also displays working times, which are derived from the cumulative data of working times for every step performed in a past and the current data stored in the first storage section.

(2) The display system of item 1, wherein the displaying section displays the working times in such a manner that an area or a length of each symbol of the steps varies in proportion to an amount of a corresponding working time.

(3) The display system of item 1, wherein each of the working times is a cumulative standard time for a working time in each step.

(4) The display system of item 1, wherein, when an operator completes an initial step, the working times for all steps are predicted on the basis of average working times accumulated in the past, so as to display an expected working time for every step.

(5) The display system of item 1, further comprising: an average working time calculating section to calculate an average working time, based on the cumulative data of working times for every step performed in a past; wherein the displaying section visually displays working times for every step on the display screen, based on calculated results derived by the average working time calculating section.

(6) The display system of item 1, wherein, in a mid-course of an initial step, a working time required for each step is predicted by measuring a time interval of key touch or any other unit operation performed by an operator, and then, working times for all steps are predicted on the basis of average working times accumulated in a past, so as to display an expected working time for every step.

(7) The display system of item 1, further comprising: a controlling center to which the cumulative data of working times for every step performed in a past are transmitted from the second storage section through a transmission line; wherein the controlling center predicts working times of the steps included in the consecutive operation, based on the cumulative data of working times and sends back them to the second storage section; and wherein the displaying section displays the working times with cumulative standard times and/or in such a manner that an area or a length of each symbol of the steps varies in proportion to an amount of a corresponding working time.

(8) A display system for displaying steps included in a consecutive operation on a display screen, comprising: a measuring section to measure a working time for every step; a first storage section to store current data of the working time measured by the measuring section; a second storage section to store cumulative data of working times for every step performed in a past; an average working time rewriting section to rewrite an average working time in a past, by performing a recalculating operation after adding the cumulative data of working times for every step performed in a past to the current data stored in the first storage section; and a displaying section to display the steps included in the consecutive operation on the display screen; wherein the displaying section also displays working times rewritten by the average working time rewriting section.

(9) The display system of item 8, wherein the displaying section displays the working times in such a manner that an area or a length of each symbol of the steps varies in proportion to an amount of a corresponding working time.

(10) The display system of item 8, wherein each of the working times is a cumulative standard time for a working time in each step.

(11) The display system of item 8, wherein, when an operator completes an initial step, the working times for all steps are predicted on the basis of average working times accumulated in the past, so as to display an expected working time for every step.

(12) The display system of item 8, further comprising: an average working time calculating section to calculate an average working time, based on the cumulative data of working times for every step performed in a past; wherein the displaying section visually displays working times for every step on the display screen, based on calculated results derived by the average working time calculating section.

(13) The display system of item 8, wherein, in a mid-course of an initial step, a working time required for each step is predicted by measuring a time interval of key touch or any other unit operation performed by an operator, and then, working times for all steps are predicted on the basis of average working times accumulated in a past, so as to display an expected working time for every step.

(14) The display system of item 8, further comprising: a controlling center to which the cumulative data of working times for every step performed in a past are transmitted from the second storage section through a transmission line; wherein the controlling center predicts working times of the steps included in the consecutive operation, based on the cumulative data of working times and sends back them to the second storage section; and wherein the displaying section displays the working times with cumulative standard times and/or in such a manner that an area or a length of each symbol of the steps varies in proportion to an amount of a corresponding working time.

Further, to overcome the abovementioned problems, other display systems, embodied in the present invention, will be described as follow:

(15) A display system, characterized in that there are provided:

measuring means for measuring a working time for every step;

storage means for storing data measured by the measuring section;

accumulated data storage means for storing accumulated data of working times for every step in a past; and

a displaying means; and

the working time is recalculated from the accumulated data of working times for every step in the past and the measured data stored in the storage means, so as to display them in proportion to a working amount.

(16) A display system, characterized in that there are provided:

measuring means for measuring a working time for every step;

storage means for storing data measured by the measuring section;

accumulated data storage means for storing accumulated data of working times for every step in a past; and

displaying means; and

the accumulated data of working times for every step in the past and the measured data stored in the storage means are added to each other to recalculate them, and then, the average working times in the past are rewritten, so as to display them in proportion to a working amount.

(17) The display system, described in item 15 or 16, characterized in that,

in the display screen of the displaying means, the working amount of each step is displayed in such a manner that an area or a length of each symbol of the steps varies in proportion to the working amount.

(18) The display system, described in item 15 or 16, characterized in that,

in the display screen of the displaying means, a cumulative standard time for a working time in each step is displayed.

(19) The display system, described in anyone of items 15-18, characterized in that,

when an operator completes an initial step, the working times for all steps are predicted from accumulated average working times, so as to display an expected working time for every step.

(20) The display system, described in anyone of items 15-18, characterized in that,

a working time of a step is measured by the measuring means for every step, and then, the measured results are stored in the storage means, and further, the stored data are sent to the accumulated data storage means, and as the next step, the working time is calculated by an average working time calculating section, based on the accumulated data of the working time in the past, and then, based on the calculating results in the above, the working time of each step is visually displayed on displaying means.

(21) The display system, described in anyone of items 15-18, characterized in that,

in a mid-course of an initial step, a working time required for each step is predicted by measuring a time interval of key touch, etc., performed by an operator, and then, the working times of all steps are predicted on the basis of average working times accumulated in the past, so as to display an expected working time for every step.

(22) The display system, described in anyone of items 15-18, characterized in that,

the accumulated data of the working time in the past are transmitted to a controlling center residing in a system in which an operator currently performs an operation, and a working time of each step is further predicted from the accumulated data of the working times in the past, transmitted from a plurality of systems, and then, such the predicted working times are sent back to the plurality of systems, so as to display the working times with cumulative standard times and/or in such a manner that an area or a length of each symbol of the steps varies in proportion to an working amount.

### BRIEF DESCRIPTION OF THE DRAWINGS

Other objects and advantages of the present invention will become apparent upon reading the following detailed description and upon reference to the drawings in which:

FIG. 1 shows a block diagram of the display system desirably embodied in the present invention;

FIG. 2 shows a flowchart of a data storing operation of the working time in the past and a data rewriting operation;

FIG. 3 shows actual working times consumed by an operator A;

FIG. 4 shows an example of accumulated data;

FIG. 5 shows a flowchart of a system for displaying the expected working times of all steps, at each of which each of operations of all steps is completed, when the initial step is finalized;

FIG. 6 shows an example of displaying mode for visually displaying expected working times of all steps;

FIG. 7 shows another example of displaying mode for visually displaying expected working times of all steps;

FIG. 8 shows an example of displaying working times with cumulative standard times;

FIG. 9 shows an example of displaying working times with cumulative standard times, while displaying the working times with areas or lengths of the symbols;

FIG. 10 shows a flowchart of a system in regard to the fifth embodiment;

FIG. 11 shows another embodiment of the present invention;

FIG. 12 shows another embodiment of the present invention;

FIG. 13 shows an conventional screen configuration for displaying each of the steps; and

FIG. 14 shows another conventional screen configuration for displaying each of the steps.

### DETAILED DESCRIPTION OF THE PREFERRED EMBODIMENT

Referring to the drawings, desirable embodiments will be detailed in the following.

### First Embodiment

The first embodiment is an example of performing an operation for calculating an average working time at each of the steps for every operator, and an operation for rewriting the average working time at each of the steps.

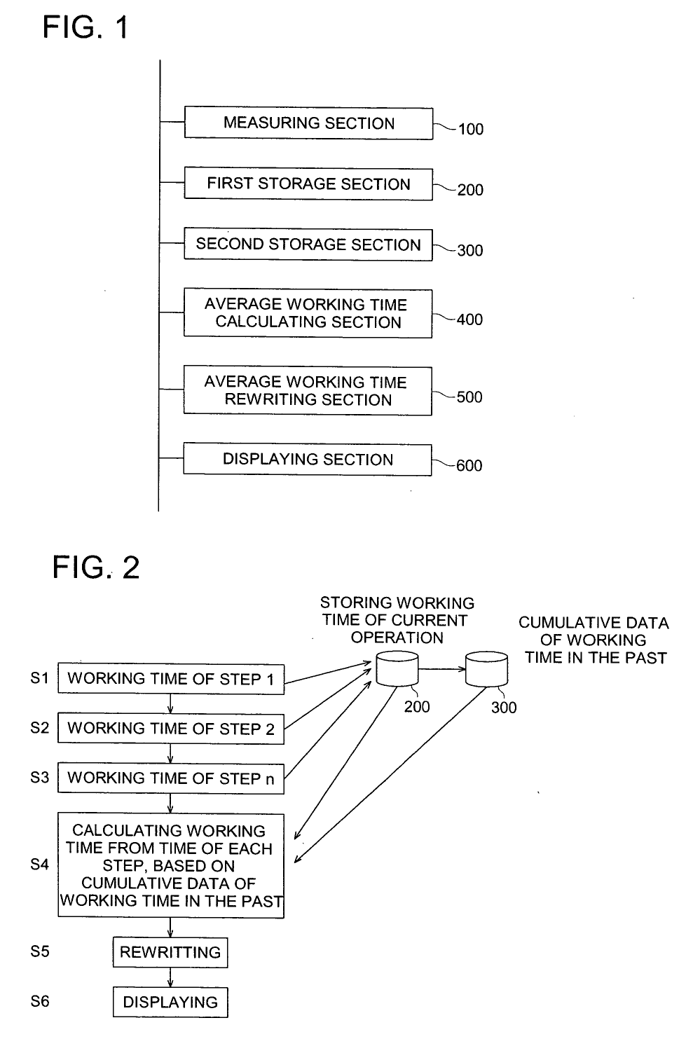

As hardware employed in the first embodiment shown in FIG. 1, the display system fundamentally includes measuring section 100 for measuring the working time at each of the steps, first storage section 200 for storing the measured data acquired by means of measuring section 100, second storage section 300, average working time calculating section 400 for calculating an average working time in a past, average working time rewriting section 500 for rewriting the average working time in the past and displaying section 600. The working time measured by measuring section 100 is stored in first storage section 200. It is desirable that the measuring and storing operation is performed at the time of the completion of each step.

For instance, ROM (Read Only Memory), Flash ROM, RAM (Random Access Memory) can be employed for first storage section 200 and second storage section 300.

FIG. 2 shows a flowchart of the data storing operation of the working time in the past and the data rewriting operation.

As shown in FIG. 2, initially, measuring section 100 measures a working time for each step (S1, S2, S3).

Then, the measured results are stored in first storage section 200. Further, the stored data are sent to second storage section 300, serving as a cumulative data storage.

As the next step, calculating section 400, serving as an average working time calculating section, calculates a working time from the time of each step, based on cumulative data of the working times in the past (S4).

Further, average working time rewriting section 500 rewrites the average working time in the past (S5). Then, the working time of each step is visually displayed on displaying section 600 (S6).

An example of the rewriting operation, performed by average working time rewriting section 500, will be detailed in the following.

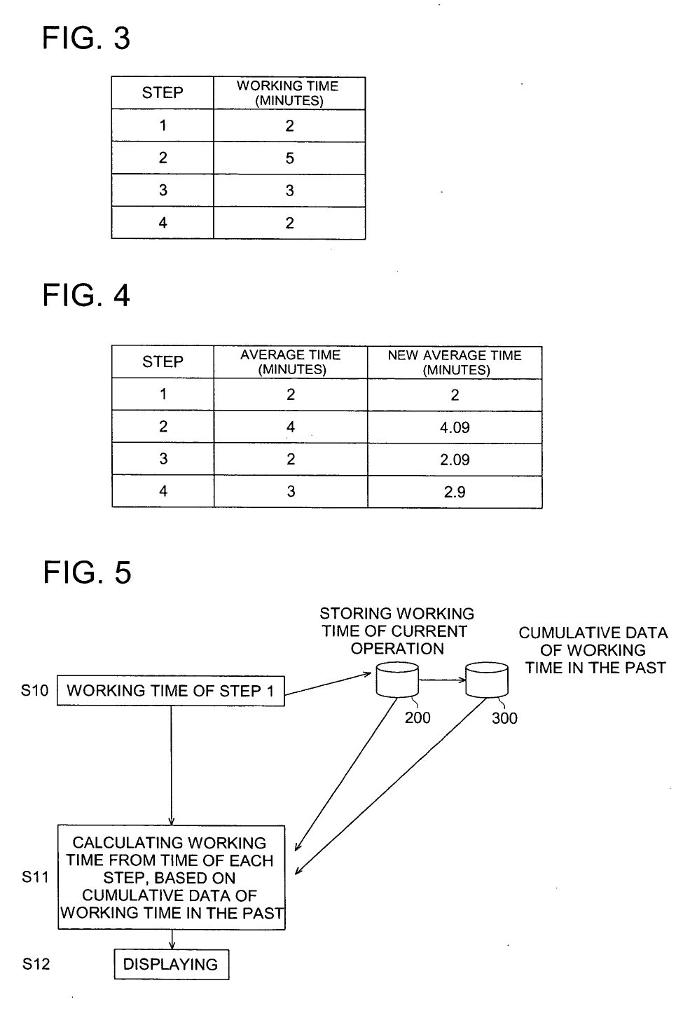

For instance, it is assumed that FIG. 3 indicates actual working times consumed by operator A. New data of average working time will be rewritten on the basis of them. In the first step, when the average working time is two minutes (as shown in the middle column of FIG. 4) and this value is an average value based on 10 data sets, the new average value will be derived form the following equation.

(2×10+2)/11=2 (new average value)

As for the second step, in the same manner as the above,

(4×10+5)/11=4.09 (new average value).

As for the third step, in the same manner as the above,

(2×10+3)/11=2.09 (new average value).

As for the fourth step, in the same manner as the above,

(3×10+2)/11=2.9 (new average value).

Accordingly, as shown in FIG. 4, the average working times indicated in the middle column are rewritten to the values indicated in the right column.

### Second Embodiment

In the second embodiment, when the operator completes the initial step, the working times of all steps are predicted on the basis of average working times accumulated in the past, so as to display an expected working time for every step.

FIG. 5 shows a flowchart of a system for displaying the expected working times of all steps, at each of which each of operations of all steps is completed, when the initial step (in this case, step 1) is finalized.

As shown in FIG. 5, initially, measuring section 100 measures a working time for step 1 (S10).

Then, the measured results are stored in first storage section 200. Further, the stored data are sent to second storage section 300, serving as a cumulative data storage.

As the next step, calculating section 400, serving as an average working time calculating section, calculates a working time from the time of step 1, based on cumulative data of the working time in the past (S11).

Then, based on the calculating result, the working times after step 1 are visually displayed on displaying section 600 (S12).

Concretely speaking with referring to FIG. 3, the working time of step 1 performed by operator A is 2 minutes. According to the accumulated data shown in the middle column of FIG. 4, the average working times of all steps are 4 minutes in step 2, 2 minutes in step 3 and 3 minutes in step 4, respectively.

Accordingly, when the operator completes the initial step (in this case, step 1), the expected working times of all steps, at each of which each of operations of all steps is completed, can be predicted by indicating as follow.

2+4+2+3=11

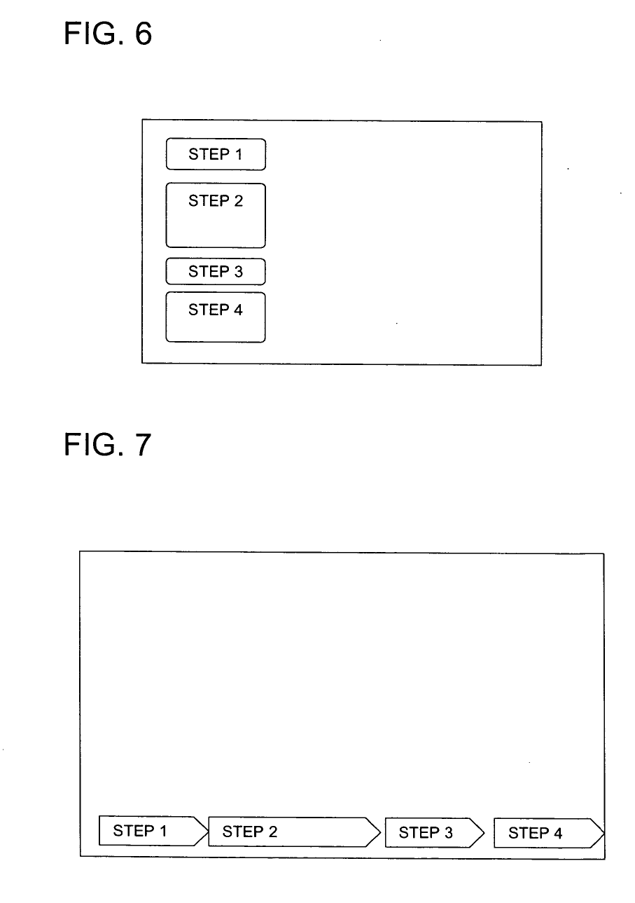

FIG. 6 or FIG. 7 shows an exemplified display mode for visually displaying the expected working times of all steps.

When an operator performs an ordering operation at a store counter, through computer ordering software or on a Web site on a computer screen, this kind of visual display as shown in FIG. 6 or FIG. 7 allows the operator to visually recognize the total working time, the currently consumed time for operation and the residual working time in parallel and ratio-wise.

Further, when plural operators perform ordering operations through computer ordering software for plural operators or the same operation, the histories of such the operations are stored in the storage in an accumulated base. Accordingly, since each of the working times visually varies on the display screen by re-calculating them based on the accumulated information at the time of displaying, it becomes possible to improve the estimation accuracy of the working times.

### Third Embodiment

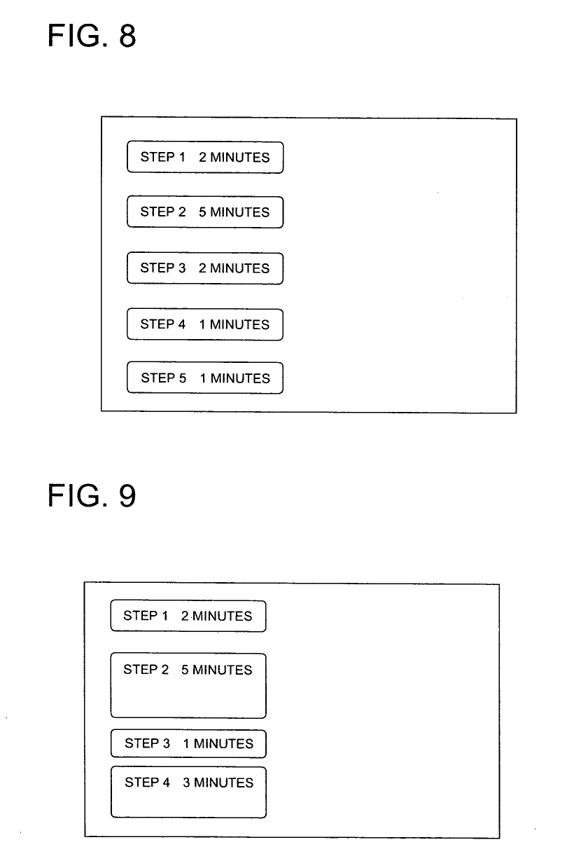

Being different from the first embodiment, the third embodiment is an example of displaying cumulative standard times, instead of displaying the times with areas or lengths of the symbols. FIG. 8 shows an example of the third embodiment.

### Fourth Embodiment

The fourth embodiment is an example of displaying cumulative standard times, while displaying the times with areas or lengths of the symbols. FIG. 9 shows an example of the fourth embodiment.

### Fifth Embodiment

The fifth embodiment is an improved version of the second embodiment in which, when the operator completes the initial step, the working times of all steps are predicted on the basis of average working times accumulated in the past, so as to display an expected working time for every step.

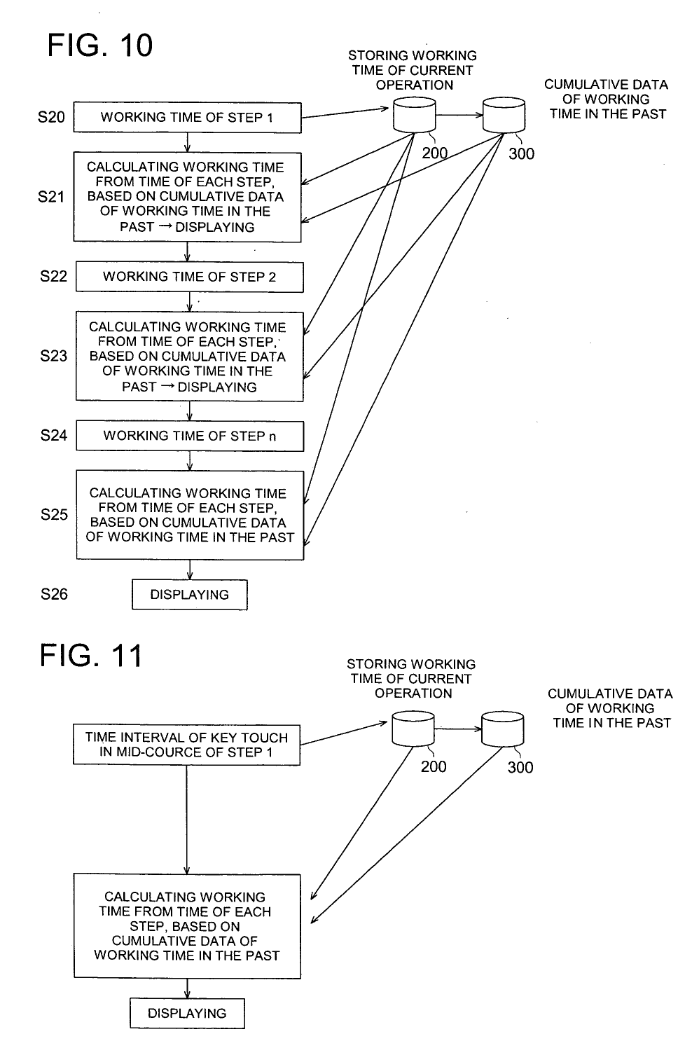

FIG. 10 shows a flowchart of a system with respect to the fifth embodiment.

As shown in FIG. 10, initially, measuring section 100 measures a working time for step 1 (S20). Then, the measured results are stored in first storage section 200. Further, the stored data are sent to second storage section 300, serving as an accumulated data storage. As the next step, calculating section 400, serving as an average working time calculating section, calculates a working time from the time of step 1, based on accumulated data of the working time in the past. Then, based on the calculating results in the above, the working time of step 1 is visually displayed on displaying section 600 (S21).

Successively, measuring section 100 measures a working time for step 2 (S22). Then, the measured results are stored in first storage section 200. Further, the stored data are sent to second storage section 300, serving as a cumulative data storage. As the next step, calculating section 400, serving as an average working time calculating section, calculates a working time from the time of step 2, based on cumulative data of the working time in the past. Then, based on the calculating results in the above, the working time of step 2 is visually displayed on displaying section 600 (S23).

Successively, measuring section 100 measures a working time for step “n” (S24). Then, the measured results are stored in first storage section 200. Further, the stored data are sent to second storage section 300, serving as a cumulative data storage. As the next step, calculating section 400, serving as an average working time calculating section, calculates a working time from the time of step “n”, based on accumulated data of the working time in the past (S25). Then, based on the calculating results in the above, the working time of step “n” is visually displayed on displaying section 600 (S26).

### Sixth Embodiment

In the sixth embodiment, even in a mid-course of an initial step, a working time required for each step is predicted by measuring a time interval of key touch, etc. Then, the working times of all steps are predicted on the basis of average working times accumulated in the past, so as to display an expected working time for every step.

As shown in FIG. 11, the operator measures the time interval of key touch in the mid-course of the initial step. Then, the measured results are stored in first storage section 200. Since data of the relationships between the time intervals and the working times are stored in first storage section 200, the working times can be predicted from the relationships.

Further, the stored data of the working times are sent to second storage section 300, serving as a cumulative past data storage. As the next step, based on cumulative data of the working time in the past, a working time of each step is calculated, so as to visually display it on displaying section 600.

### Seventh Embodiment

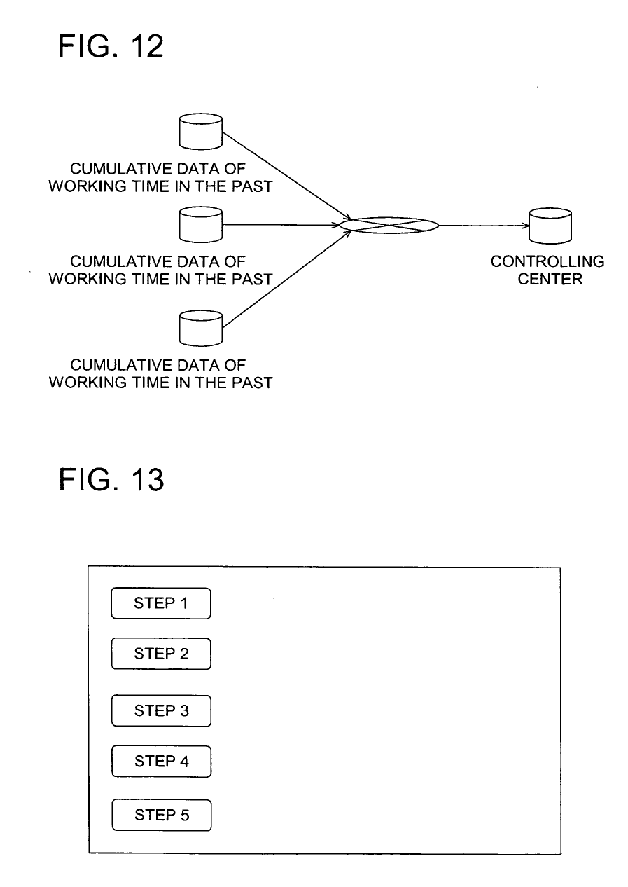

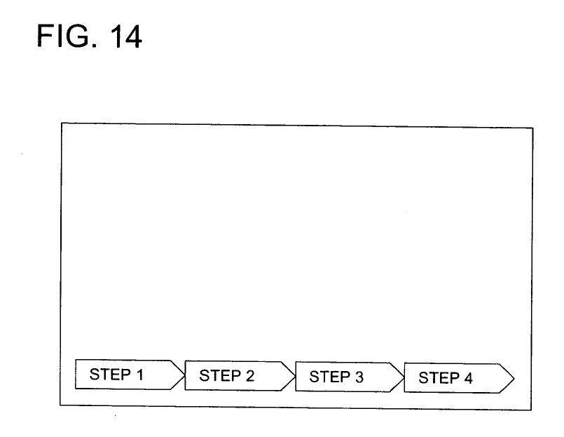

As shown in FIG. 12, in the seventh embodiment, cumulative data of the working time in the past will be transmitted to a controlling center residing in a system in which an operator currently performs an operation. In the controlling center, based on cumulative data of the working time in the past, transmitted from a plurality of systems, a working time of each step is predicted. Then, such the predicted working times are sent back to the plurality of systems, so as to display the working times with cumulative standard times and/or in such a manner that an area or a length of each symbol of the steps varies in proportion to an working amount.

According to the seventh embodiment, since cumulative data of the working time in the past are collected from a plurality of systems when an operating frequency of a system is small, it becomes possible to improve an accuracy of predicting an average working time of each step.

It is desirable that protocols for e-mail (SMTP), ftp, http, ect. are employed for the transmission method.

Disclosed embodiment can be varied by a skilled person without departing from the spirit and scope of the invention.

What is claimed is:

1. A display system for displaying steps included in a consecutive operation on a display screen, comprising:
a measuring section to measure a working time for every step;
a first storage section to store current data of said working time measured by said measuring section;
a second storage section to store cumulative data of working times for every step performed in a past; and
a displaying section to display said steps included in said consecutive operation on said display screen;
wherein said displaying section also displays working times, which are derived from said cumulative data of working times for every step performed in a past and said current data stored in said first storage section.

2. The display system of claim 1,
wherein said displaying section displays said working times in such a manner that an area or a length of each symbol of said steps varies in proportion to an amount of a corresponding working time.

3. The display system of claim 1,
wherein each of said working times is a cumulative standard time for a working time in each step.

4. The display system of claim 1,
wherein, when an operator completes an initial step, said working times for all steps are predicted on the basis of average working times accumulated in the past, so as to display an expected working time for every step.

5. The display system of claim 1, further comprising:
an average working time calculating section to calculate an average working time, based on said cumulative data of working times for every step performed in a past;
wherein said displaying section visually displays working times for every step on said display screen, based on calculated results derived by said average working time calculating section.

6. The display system of claim 1,
wherein, in a mid-course of an initial step, a working time required for each step is predicted by measuring a time interval of key touch or any other unit operation performed by an operator, and then, working times for all steps are predicted on the basis of average working times accumulated in a past, so as to display an expected working time for every step.

7. The display system of claim 1, further comprising:
a controlling center to which said cumulative data of working times for every step performed in a past are transmitted from said second storage section through a transmission line;
wherein said controlling center predicts working times of said steps included in said consecutive operation, based on said cumulative data of working times and sends back them to said second storage section; and
wherein said displaying section displays said working times with cumulative standard times and/or in such a manner that an area or a length of each symbol of said steps varies in proportion to an amount of a corresponding working time.

8. A display system for displaying steps included in a consecutive operation on a display screen, comprising:
a measuring section to measure a working time for every step;
a first storage section to store current data of said working time measured by said measuring section;
a second storage section to store cumulative data of working times for every step performed in a past;
an average working time rewriting section to rewrite an average working time in a past, by performing a recalculating operation after adding said cumulative data of working times for every step performed in a past to said current data stored in said first storage section; and
a displaying section to display said steps included in said consecutive operation on said display screen;
wherein said displaying section also displays working times rewritten by said average working time rewriting section.

9. The display system of claim 8,
wherein said displaying section displays said working times in such a manner that an area or a length of each symbol of said steps varies in proportion to an amount of a corresponding working time.

10. The display system of claim 8,
wherein each of said working times is a cumulative standard time for a working time in each step.

11. The display system of claim 8,
wherein, when an operator completes an initial step, said working times for all steps are predicted on the basis of average working times accumulated in the past, so as to display an expected working time for every step.

12. The display system of claim 8, further comprising:
an average working time calculating section to calculate an average working time, based on said cumulative data of working times for every step performed in a past;
wherein said displaying section visually displays working times for every step on said display screen, based on calculated results derived by said average working time calculating section.

13. The display system of claim 8,
wherein, in a mid-course of an initial step, a working time required for each step is predicted by measuring a time interval of key touch or any other unit operation performed by an operator, and then, working times for all steps are predicted on the basis of average working times accumulated in a past, so as to display an expected working time for every step.

14. The display system of claim 8, further comprising:
a controlling center to which said cumulative data of working times for every step performed in a past are transmitted from said second storage section through a transmission line;
wherein said controlling center predicts working times of said steps included in said consecutive operation, based on said cumulative data of working times and sends back them to said second storage section; and
wherein said displaying section displays said working times with cumulative standard times and/or in such a manner that an area or a length of each symbol of said steps varies in proportion to an amount of a corresponding working time.
